(19) United States
(12) Patent Application Publication
(10) Pub. No.: US 2011/0215925 A1
(43) Pub. Date: Sep. 8, 2011

(54) METHOD AND APPARATUS FOR FALL DETECTION AND ALARM

(75) Inventors: Ningjiang Chen, Shanghai (CN); Sheng Jin, Shanghai (CN)

(73) Assignee: KONINKLIJKE PHILIPS ELECTRONICS N.V., EINDHOVEN (NL)

(21) Appl. No.: 13/128,671

(22) PCT Filed: Nov. 9, 2009
(86) PCT No.: PCT/IB09/54953

§ 371 Date: May 11, 2011

(30) Foreign Application Priority Data
Nov. 14, 2008 (CN) 200810176652.5

(51) Int. Cl. G08B 21/00

(52) U.S. Cl. 340/540

(57) ABSTRACT

The invention relates to a method and apparatus for indicating a fall of a user by means of an alarm message. According to the invention, the apparatus (20) comprises a unit (21) for receiving a first alarm message (FAM) sent by a fall detector (30) intended to be worn on the user, the first alarm message indicating whether a fall event in association with the user occurs, which first alarm message is determined by air-pressure data and user motion data detected by the fall detector (30); a unit (22) for acquiring weather data reflecting the weather condition of the area where the user is situated; a unit (23) for determining whether or not the first alarm message is reliable, based on said weather data and predetermined criteria; and an output unit (24) for generating and outputting a fall alarm when the first alarm message is determined as being reliable. The apparatus dramatically reduces false alarms by acquiring weather data for determining the reliability of alarm messages generated by the air-pressure sensor.

### FIELD OF THE INVENTION

The invention relates to fall detection, particularly to a method and apparatus for indicating a fall of a user by means of an alarm message, and to a method and system for fall detection.

### BACKGROUND OF THE INVENTION

EP 1 642 248, the contents of which are herein incorporated by reference, describes a wearable multi-modality fall detector which uses both an accelerometer and a barometer so as to increase the reliability of fall detection. From the air pressure measured by the barometer, it is possible to get the altitude change of the fall detector during a fall. Usually, the altitude of the fall detector will decrease by at least 50 cm if it is worn on the upper part of the body, which can be captured by the barometer. Such a fall detector can be used in a conventional emergency response system for fall alarm messages and aid from a third party.

FIG. 1 is the schematic view of a prior-art emergency response system 10. As shown in FIG. 1, the emergency response system 10 comprises a fall detector 11 which is intended to be worn on a human body, a home communicator 12 and a call center 13. Once a fall is detected by the fall detector 11, it will send a fall alarm message to the home communicator 12. The home communicator 12 will contact the call center 13 for an emergency call via a communication medium, for example, a telephone line.

Although the above-mentioned fall detector 11 increases the reliability of fall detection by incorporating a barometer, the detection result of this fall detector is influenced by weather conditions just because of the reliability of the barometer. Specifically, there may be both a missed fall and a false alarm.

### SUMMARY OF THE INVENTION

The present invention is based on the recognition that the air pressure will be low on a stormy day and high on a sunny day. Furthermore, the air pressure will increase when the altitude decreases, whereas it will decrease when the altitude increases. However, the barometer is sensitive to bad weather, such as a storm. Since the air pressure on a stormy day will decrease to a level which seems to increase the altitude, the decreased altitude in a fall will be counteracted. Then a fall will be missed. Once the storm has stopped, the air pressure will increase, which seems to decrease the altitude. It may generate a false alarm. If the storm is not continuous, the air pressure will alternately decrease and increase. The barometer is not reliable anymore.

The present invention provides a method and apparatus which addresses the above-mentioned problems.

According to one aspect of the present invention, an apparatus is provided for indicating a fall of a user by means of an alarm message. The apparatus comprises:

a receiving unit configured to receive a first alarm message sent by a fall detector intended to be worn on said user, the first alarm message indicating whether a fall event in association with the user occurs, which first alarm message is determined by air-pressure data and user motion data detected by the fall detector;

a acquiring unit configured to acquire weather data reflecting weather conditions of the area where the user is situated;

a determining unit configured to determine whether or not the first alarm message is reliable, based on said weather data and predetermined criteria; and

an output unit configured to generate and output a fall alarm when the first alarm message is determined as being reliable and indicates that the fall event occurs.

The apparatus dramatically reduces false alarms by acquiring weather data for determining the reliability of an alarm message generated by the air-pressure sensor.

In a further embodiment, the receiving unit is arranged to receive a second alarm message sent by the fall detector. The second alarm message indicates whether the fall event in association with the user occurs, which second alarm message is determined by user motion data detected by the fall detector. When the first alarm message is determined as being not reliable and the second alarm message indicates that the fall event occurs, the output unit generates and outputs a fall alarm.

By enabling the second alarm message associated with user motion data only, even when the weather is not favorable, the apparatus can still report a fall event accordingly so as to avoid missing alarms of fall events.

In an embodiment, the acquisition unit acquires the weather data from any one of a call center, the Internet, a user interface or a third party.

In another embodiment, the acquisition unit comprises a measurement unit for measuring the weather condition of the area where the user is situated. It is advantageous that the measurement unit comprises one of a barometer and a thermometer.

In a further embodiment, the apparatus comprises a sending unit for sending the generated fall alarm to a call center.

Other objects and results of the present invention will become more apparent and easily understood from the following description with reference to the accompanying drawings.

### DESCRIPTION OF THE DRAWINGS

The present invention will hereinafter be described and explained in more detail with reference to some embodiments and the drawings, wherein:

FIG. 1 is a schematic view of an emergency response system of the prior art;

FIG. 2 is a block diagram of the apparatus according to the present invention for indicating a fall of a user by means of an alarm message;

FIG. 3 shows the generation of a first and a second alarm message according to the present invention; and

FIG. 4 is a flowchart of the fall detection method according to the present invention.

The same reference signs in the Figures indicate similar or corresponding features and/or functionalities.

### DESCRIPTION OF EMBODIMENTS

The embodiments of the present invention will hereinafter be described in more detail with reference to the drawings.

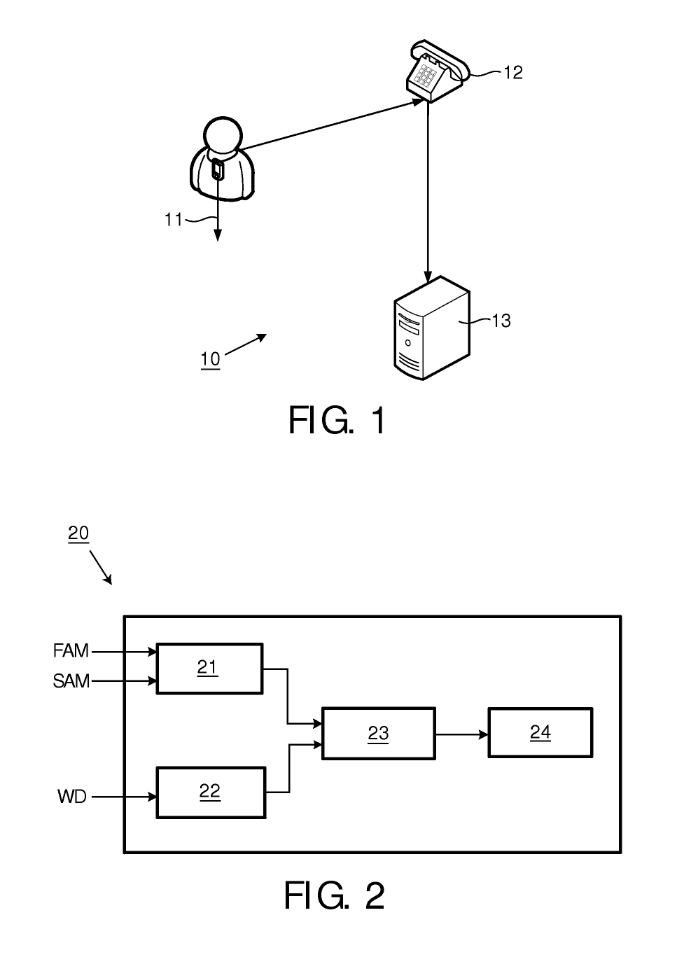

FIG. 2 is a block diagram of the structure of the apparatus 20 according to the present invention for indicating a fall of a user by means of an alarm message.

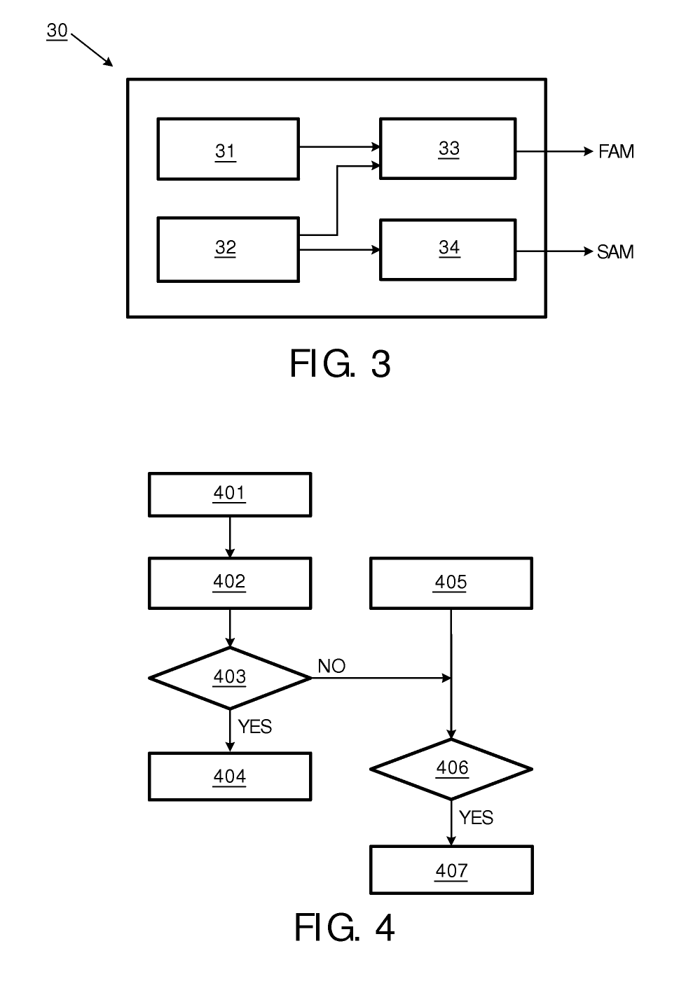

The apparatus 20 comprises: a receiving unit 21 configured to receive a first alarm message FAM sent by a fall detector 30 (see FIG. 3) intended to be worn on said user, the first alarm message indicating whether a fall event in association with the user occurs and indicating that the first alarm message is determined by air-pressure data and user motion data detected by the fall detector. The generation of the first alarm message FAM will be explained with reference to FIG. 3.

The apparatus 20 further comprises an acquiring unit 22 configured to acquire weather data WD reflecting the weather condition of the area where the user is situated.

In an embodiment, the acquiring unit 22 queries the local weather condition, for example, via the telephone and obtains weather data reflecting the weather condition. The weather data comprises, but is not limited to, air pressure, temperature, humidity, wind power, wind speed, etc.

The query can be sent to the call center or web 2.0 services on the Internet or weather services provided by other third parties. Since the home address is known to the call center, the real-time weather condition around the home is accessible.

In another embodiment, other than acquiring weather data from outside (such as a call center, the Internet, a user interface or third parties), the acquiring unit 22 may comprise a unit (not shown) to measure the weather condition of the area where the user is situated.

A simple weather device uses a barometer. This method has the advantage that it can exactly know the status of the environment inside a room in case the air pressure in a closed room may be different from that outside. Alternatively, the measuring unit may be a thermometer.

The apparatus 20 further comprises a determining unit 23 configured to determine whether or not the first alarm message is reliable, based on said weather data and predetermined criteria.

The predetermined criteria adopted by the determining unit 23 comprise at least one threshold for respective weather data for determining if the weather condition is either good or not good.

For example, when the weather data is wind speed, the adopted predetermined criterion may be the relationship between the acquired wind speed and a predetermined wind speed. For the case of querying the local weather condition, the unit 23 may use the following predetermined criteria so as to determine if the weather condition is either good or not good. If it is sunny or cloudy with low wind speeds outdoors, such as less than 5.4 m/s, the weather condition is good. If it is rainy and/or with high wind speeds outdoors, such as more than 5.5 m/s, the weather condition is not good.

In addition, if the weather data is air pressure, the adopted predetermined criterion may be the relationship between the obtained air-pressure value and a predetermined air-pressure value, or the relationship between the change rate for the obtained air pressure in a short period and a predetermined change rate.

For example, for the case of measuring the home weather condition, several approaches can be used by the determining unit 23. One approach is to check the variation of barometer readings in a short period of time. If there is a large variation, the weather condition is not good. Otherwise, it is good. Details can be found in the prior art and will therefore not be described here.

Another approach is to check the absolute air pressure. The normal air pressure on a sunny day at sea level is 101.325 kPa. In bad weather, the air pressure is usually between 97.0 and 101.0 kPa. In good weather, the air pressure is usually between 102 and 103 kPa. If the ground level is not at sea level, the air-pressure threshold for bad weather needs to be adjusted accordingly by using the local weather history value. The higher the ground level, the lower the threshold.

The present invention is not limited to these criteria. Rather, the predetermined criterion may be the relationship between the obtained temperature and humidity values and the predetermined temperature and humidity values.

It will be evident to the skilled person that it is possible to conceive combinations of the above-mentioned criteria so as to carry out this invention.

The apparatus 20 further comprises an output unit 24 configured to generate and output a fall alarm when the first alarm message is determined as being reliable and indicates that the fall event occurs.

Since, as described above, the first alarm message is influenced by weather conditions, it is possible to avoid false alarms because of bad weather by determining whether or not the first alarm message sent from the fall detector is reliable, based on weather data and predetermined criteria.

In an embodiment, the receiving unit 21 is further arranged to receive a second alarm message SAM sent by the fall detector, the second alarm message indicating whether the fall event in association with the user occurs, which second alarm message is determined by user motion data detected by the fall detector. The generation of the second alarm message SAM will be described with reference to FIG. 3.

When the first alarm message is determined as being not reliable and the second alarm message indicates that the fall event occurs, the output unit 24 generates and outputs a fall alarm.

Since the above-mentioned apparatus 20 receives the user motion data-associated second alarm message only when the weather is not favorable and influences the reliability of the first alarm message, the apparatus 20 ignores the first alarm message and adopts the second alarm message. When the second alarm message indicates that a fall occurs, the apparatus 20 can therefore still report a fall event accordingly so as to avoid missing alarms of fall events.

FIG. 3 is a schematic view of the generation of the first and the second alarm message according to the present invention.

As shown in FIG. 3, the fall detector 30 according to the present invention comprises an air-pressure sensor 31 and at least one motion sensor 32.

It is advantageous that the air-pressure sensor 31 is a barometer for measuring the air-pressure data and the motion sensor 32 is an accelerometer for measuring the user motion data.

It will be evident to the person skilled in the art that the air-pressure sensor 31 in the present invention may be any sensor other than a barometer that is capable of detecting air pressure, and the motion sensor 32 may be any sensor other than the accelerometer that is capable of detecting user motion data.

The detector 30 further comprises a first unit 33 configured to generate a first fall alarm message FAM based on air-pressure data measured by the air-pressure sensor 31 and user motion data detected by the at least one motion sensor 32 so as to indicate whether a fall event in association with the user occurs.

The detector 30 further comprises a second unit 34 configured to generate a second fall alarm message SAM based on the user motion data detected by the at least one motion sensor 32 so as to indicate whether the fall event in association with the user occurs.

The apparatus 20 and the fall detector 30 described above can be used in a fall detection system, as shown in FIG. 1, to replace the fall detector 11 and the home communicator 12. As the apparatus 20 acquires weather data for determining the reliability of the first alarm message, the fall detection system provided by this invention can dramatically reduce false alarms.

FIG. 4 is a flowchart of the fall detection method according to the present invention.

The fall detection method according to the present invention comprises a step 401 of receiving a first alarm message sent by the fall detector 30 intended to be worn on a user, the first alarm message indicating whether a fall event in association with the user occurs, which first alarm message is determined by air-pressure data and user motion data detected by the fall detector 30. The function of step 401 can be executed by the receiving unit 21.

The method further comprises a step 402 of acquiring weather data reflecting the weather condition of the area where the user is situated. The function of step 402 can be executed by the acquiring unit 22.

The method further comprises a step 403 of determining whether or not the first alarm message is reliable, based on the acquired weather data and predetermined criteria. The function of step 403 can be executed by the determining unit 23.

The method further comprises a step 404 of generating and outputting a fall alarm when the first alarm message is determined as being reliable and indicates that the fall event occurs. The function of step 404 can be executed by the output unit 24.

In an embodiment, the method further comprises a step 405 of receiving a second alarm message sent by the fall detector 30, the second alarm message indicating whether the fall event in association with the user occurs, which second alarm message is determined by user motion data detected by the fall detector 30. The function of step 405 can be executed by the receiving unit 21.

In another embodiment, if the determining result of step 403 is NO, the method further comprises a step 406 of determining whether the second alarm message indicates that the fall occurs. The function of step 406 can be executed by the determining unit 23.

In an embodiment, the method further comprises a step 407 of generating and outputting a fall alarm when the second alarm message indicates that the fall occurs. The function of step 407 can be executed by the output unit 24.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim or in the description. Use of the indefinite article “a” or “an” preceding an element does not exclude the presence of a plurality of such elements. In the system claims enumerating several units, several of these units can be embodied by one and the same item of software and/or hardware. Use of the words first, second and third, etc. does not indicate any ordering. These words are to be interpreted as names.

1. An apparatus (20) for indicating a fall of a user by means of an alarm message, the apparatus comprising:
a receiving unit (21) configured to receive a first alarm message (FAM) sent by a fall detector (30) intended to be worn on said user, the first alarm message indicating whether a fall event in association with the user occurs, which first alarm message is determined by air-pressure data and user motion data detected by the fall detector (30);
a acquiring unit (22) configured to acquire weather data (WD) reflecting weather conditions of the area where the user is situated;
a determining unit (23) configured to determine whether or not the first alarm message is reliable, based on said weather data and predetermined criteria; and
an output unit (24) configured to generate and output a fall alarm when the first alarm message is determined as being reliable and indicates that the fall event occurs.

2. The apparatus according to claim 1, wherein
the receiving unit (21) is further arranged to receive a second alarm message (SAM) sent by the fall detector (30), the second alarm message indicating whether the fall event in association with the user occurs, which second alarm message is determined by user motion data detected by the fall detector (30), and
the output unit is further arranged to generate and output a fall alarm when the first alarm message is determined as being not reliable and the second alarm message indicates that the fall event occurs.

3. The apparatus according to claim 1, wherein the weather data comprise any one of air pressure, temperature, humidity, wind power and wind speed, and the predetermined criteria comprise at least one threshold for respective weather data for determining if the weather condition is either good or not good.

4. The apparatus according to claim 2, wherein
the acquisition unit (22) acquires the weather data from any one of a call center, the Internet, a user interface or a third party.

5. The apparatus according to claim 2, wherein
the acquisition unit (22) comprises a measurement unit for measuring the weather condition of the area where the user is situated.

6. The apparatus according to claim 5, wherein the measurement unit comprises one of a barometer and a thermometer.

7. The apparatus according to claim 2, further comprising a sending unit for sending the generated fall alarm to a call center.

8. A fall detection system comprising:
a fall detector (30) for detecting the fall of a user on whom the fall detector (30) is intended to be worn, the fall detector comprising an air-pressure sensor (31) and at least one motion sensor (32), and further comprising:
a first unit (33) for generating a first fall alarm message (FAM) based on air-pressure data measured by the air-pressure sensor (31) and user motion data detected by the at least one motion sensor (32) so as to indicate whether a fall event in association with the user occurs; and
a first unit (34) for generating a second fall alarm message (SAM) based on user motion data detected by the at least one motion sensor so as to indicate whether the fall event in association with the user occurs; and
the apparatus (20) according to claim 1.

9. The fall detection system according to claim 8, further comprising a call center.

10. The fall detection system according to claim 8, wherein the at least one motion sensor (32) comprises an accelerometer.

11. A fall detection method comprising the steps of:
receiving a first alarm message (FAM) sent by a fall detector (30) intended to be worn on a user, the first alarm message indicating whether a fall event in association with the user occurs, which first alarm message is determined by air-pressure data and user motion data detected by the fall detector (401);
acquiring weather data which reflect the weather condition of the area where the user is situated (402);
determining whether or not the first alarm message is reliable, based on the acquired weather data and predetermined criteria (403); and
generating and outputting a fall alarm when the first alarm message is determined as being reliable and indicates that the fall event occurs (404).

12. The method according to claim 11, further comprising the steps of:
receiving a second alarm message (SAM) sent by the fall detector (30), the second alarm message indicating whether the fall event in association with the user occurs, which second alarm message is determined by user motion data detected by the fall detector (405),
determining whether the second alarm message indicates that the fall occurs, when the first alarm message is determined as being not reliable (406), and
generating and outputting a fall alarm when the second alarm message indicates that the fall event occurs (407).

13. The method according to claim 12, wherein the weather data is acquired from any one of a call center, the Internet, a user interface or a third party.

14. The apparatus according to claim 11, wherein the weather data is the weather condition of the area where the user is situated and is measured by a measurement unit.

15. The apparatus according to claim 14, wherein the measurement unit comprises one of a barometer and a thermometer.
